(19) United States
(12) Patent Application Publication
(10) Pub. No.: US 2006/0218294 A1
(43) Pub. Date: Sep. 28, 2006

(54) Media player with user-specified newscast capabilities

(75) Inventor: Louis B. Rosenberg, Arroyo Grande, CA (US)

Correspondence Address: LAW OFFICE OF PHILIP A STEINER, 4251 SOUTH HIGUERA STREET, SUITE 800-Z, SAN LUIS OBISPO, CA, 93401, US

(73) Assignee: Outland Research, L.L.C., Pismo Beach, CA (US)

(21) Appl. No.: 11/371,896

(22) Filed: Mar. 8, 2006

Related U.S. Application Data
(60) Provisional application No. 60/761,149, filed on Jan. 23, 2006.
(60) Provisional application No. 60/665,291, filed on Mar. 26, 2005.

(51) Int. Cl. G06F 15/16

(52) U.S. Cl. 709/231

(57) ABSTRACT

Method, system and computer program product for playing contemporaneous newscasts on a media player. The media player includes an update service application in at least periodic communication with a remote content server via a communication network, a user interface functional to receive user preference information accessible by at least the update service application. The update service application is programmed to receive, and store at least one newscast provided by the remote content server. The received newscast update is stored in a local datastore for automatic and contemporaneous play by the media player in at least partial dependence on the established user preference information and generally without interruption of at least one currently playing media file. A user provides scheduling parameters for playing the received newscast.

### CROSS-REFERENCE TO RELATED APPLICATIONS

This application is a non-provisional application claiming benefit and priority under 35 U.S.C. § 119(e) from applicant's co-pending U.S. provisional applications Ser. No. 60/761,149 filed on Jan. 23, 2006; and Ser. No. 60/665,291 filed on Mar. 26, 2005. This application is also related to the abandoned U.S. provisional applications Ser. No. 60/644,417 filed on Jan. 15, 2005; Ser. No. 60/648,197 filed on Jan. 27, 2005; and Ser. No. 60/651,771 filed on Feb. 09, 2005. This application is also a related application to co-pending U.S. utility applications Ser. No. 11/223,368 filed Sep. 09, 2005; Ser. No. 11/267,079 filed on Nov. 03, 2005; and Ser. No. 11/285,534 filed Nov. 22, 2005. This application is also a related application to international application PCT/US06/04373 filed Feb. 14, 2006. All of the aforementioned patent applications are to the instant inventor of record and are all hereby incorporated by reference in their entirety.

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates generally to automated arrangement for playing of time sensitive newscasts and more specifically to a system, method and computer program product for automatically receiving, storing and playing of a contemporaneous newscast in dependence on preestablished user preferences.

### BACKGROUND

Electronic media players have become popular personal entertainment devices due to their highly portable nature and interconnectivity with existing computer networks, for example the Internet. The accessibility and simplicity in downloading music and other electronic media continues to fuel the popularity of these devices as is exemplified by Apple Computer, Inc.'s highly successful iPod™ media player. Other manufacturers have competing media players offering various functionalities and file playing compatibilities in an effort to differentiate their products in the marketplace.

As discussed in Apple Computer, Inc., patent application, US 2004/0224638 A1, Ser. No. 10/423,490 to Fadell, et al., which is herein incorporated by reference in its entirety; an increasing number of consumer products are incorporating circuitry to play musical media files and other electronic media. For example, many electronic devices such as cellular telephones and personal digital assistants (PDAs) include the ability to play electronic musical media in many of the most commonly available file formats including MP3, AVI, WAV, MPG, QT, WMA, AIFF, AU, RAM, RA, MOV, MIDI, etc. In many situations a media player is operative to play a series of short duration media files to a user, for example songs, over an extended period and in a predetermined sequence that is sometimes referred to as a playlist. In other situations, a media player is operative to play a series of short duration media files to a user over an extended period wherein the selection and/or ordering of the media files is determined by user input and/or by an automatic selection and/or sequencing process. In such ways, a user may spend extended periods of time listening to a sequence of stored media files that are accessed from local memory.

One of the popular features of media players available in the relevant art is the ability to store large amounts of media files of personally chosen media, usually music or multimedia files, in a personal library. However, other types of media files, such as news, weather, traffic and financial reports which are typically available over other more “real-time” media outlets such as radio, television and the Internet, are generally contemporaneous in nature and are not well suited for use with current media player technologies. For example, a newscast media file containing current local traffic conditions is only relevant to a driver at the time the newscasts was created and generally for periods of less than an hour thereafter. Once that time period has expired or a change in traffic conditions has occurred, the newscast has generally lost its situational relevance and is no longer of interest to the user. Therefore, an arrangement which allows a user to receive and review contemporaneous information upon a media player while in the process of listening to a sequence of non-contemporaneous media files is a desirable feature not currently available in the relevant art. In addition, an arrangement in which contemporaneous information may be automatically received and inserted into a playing sequence of previously stored non-contemporaneous media files is highly desirable, for it would present users with a seamless combination of stored media, such as songs, and time-sensitive media, such as then current news and weather and traffic reports.

### SUMMARY

Various exemplary embodiments as described herein addresses the desirable aspects lacking in the relevant art. In various exemplary methodic, systematic and computer program embodiments the functionality of a media player is expanded to access and play a series of media files stored in a local datastore while at least periodically receiving contemporaneous newscasts over a communications network and automatically playing the contemporaneous newscast among other selected media files after at least one currently playing media file has completed play. The newscast content may be further refined by location specific information and/or user defined parameters.

In an exemplary methodic embodiment, a method for playing newscasts on a media player is provided which comprises; playing a predetermined set of local media files retrieved from a local datastore over an interval; receiving a newscast from a remote content server over a communications link during the interval; storing the newscast in a temporary datastore during at least a portion of the playing of the predetermined set of local media files; completing the playing of at least one of the predetermined set of local media files even after the newscast has been stored in the temporary datastore during the interval; automatically playing the newscast after the at least one of the predetermined set of local media files has completed playing but within the interval; and, automatically resuming play of at least a portion of the predetermined set of local media files after the newscast has completed play.

In one set of related methodic embodiments, the newscast is automatically deleted from the datastore after the newscast has completed play; the automatic play of the newscast may be overridden by a user interaction with a user interface associated with the media player, where the user interaction causes the newscast to play after a currently playing local media file completes play; and, the user interaction is provided by a designated pushbutton switch associated with the user interface.

In another set of related method embodiments, the newscast received from the remote content server is dependent in part upon a predefined set of user parameters, where one of the set of user parameters includes positional information, where the positional information is provided by a GPS receiver functionally coupled to the media player; another of the set of user parameters includes a unique identifier relationally associated with either the media player or a user of the media player; the set of user parameters defines one or more types of informational content to be included in the newscast, where informational content is one of; news, traffic, weather, financial, sports and any combination thereof; and another set of user parameters includes a dimensional limitation of the newscast.

In an exemplary systematic embodiment, a system for playing newscasts on a media player is provided which comprises; a media player having operatively installed therein; a datastore local to the media player having a plurality of local media files retrievably stored therein; a transceiver functional to receive a newscast from a remote content server over a communications link; a selection process application programmed to automatically select a set of local media files from among the plurality of local media files for play within an interval; a media player application programmed to automatically play at least a portion of the selected set of local media files during the interval; complete the play of at least one of the selected set of local media files even after the newscast has been received during the interval; play the newscast within the interval; and, automatically resume play of at least a portion of the selected set of local media files after the newscast has completed play; and an update service application coupled to the transceiver; the update service application being programmed to at least store the newscast in a temporary datastore; and, cause the media player application to play the newscast after the at least one of the selected set of local media files has completed play but within the interval.

In related systematic embodiments, the selection process application is at least programmed to select the set of local media files based on one of; a user defined playlist, a random selection, an intelligent selection and any combination thereof; the newscast is received from the remote content server in at least partial dependence upon a predefined set of user parameters, where at least one of the set of user parameters includes positional information; the positional information being provided by a GPS receiver functionally coupled to the media player; and where the set of user parameters further defines one or more types of informational content to be included in the newscast; where the one or more types of informational content is one of; news, traffic, weather, financial, sports and any combination thereof.

In a computer program product embodiment, a computer program product embodied in a tangible form for playing newscasts on a media player is provided which comprises instructions executable by a processor associated with the media player to; play a predetermined set of local media files retrieved from a local datastore over an interval; receive a newscast from a remote content server over a communications link during the interval; store the newscast in a temporary datastore during at least a portion of the play of the predetermined set of local media files; automatically play the newscast only after at least one of the predetermined set of local media files has completed play but within the interval; and automatically resume play of at least a portion of the predetermined set of local media files after the newscast has completed play but within the interval.

In related computer program product embodiments, the selection process is one of; a reading of a user defined playlist, a random selection, an intelligent selection and any combination thereof; the executable instructions may be repeatable in a cycle defined by a set of user preferences; and the tangible form comprises magnetic media, optical media, logical media and any combination thereof.

### BRIEF DESCRIPTION OF THE DRAWINGS

The features and advantages will become apparent from the following detailed description when considered in conjunction with the accompanying drawings. Where possible, the same reference numerals and characters are used to denote like features, elements, components or portions. Optional components or feature are generally shown in dashed or dotted lines. It is intended that changes and modifications can be made to the described embodiment without departing from the true scope and spirit of the subject invention.

FIG. 1—depicts a generalized and exemplary block diagram of a media player.

FIG. 2—depicts an exemplary detailed block diagram illustrating receipt of a newscast from a remote content server.

FIG. 3—depicts an exemplary programmatic arrangement in which the newscast is intelligently stored in datastore for intelligent playback by a media player.

FIG. 4—depicts,an exemplary flow chart of the intelligent newscast playback.

### DETAILED DESCRIPTION

In various embodiments, a media player is provided with expanded capabilities to receive contemporaneous newscasts from an external content provider. The newscasts are 5 intelligently played according to a users' preestablished receiving and playback preferences. Where necessary, computer programs, algorithms and routines are envisioned to be programmed in a high level language object oriented language, for example Java™, C, C++, C#, or Visual Basic™.

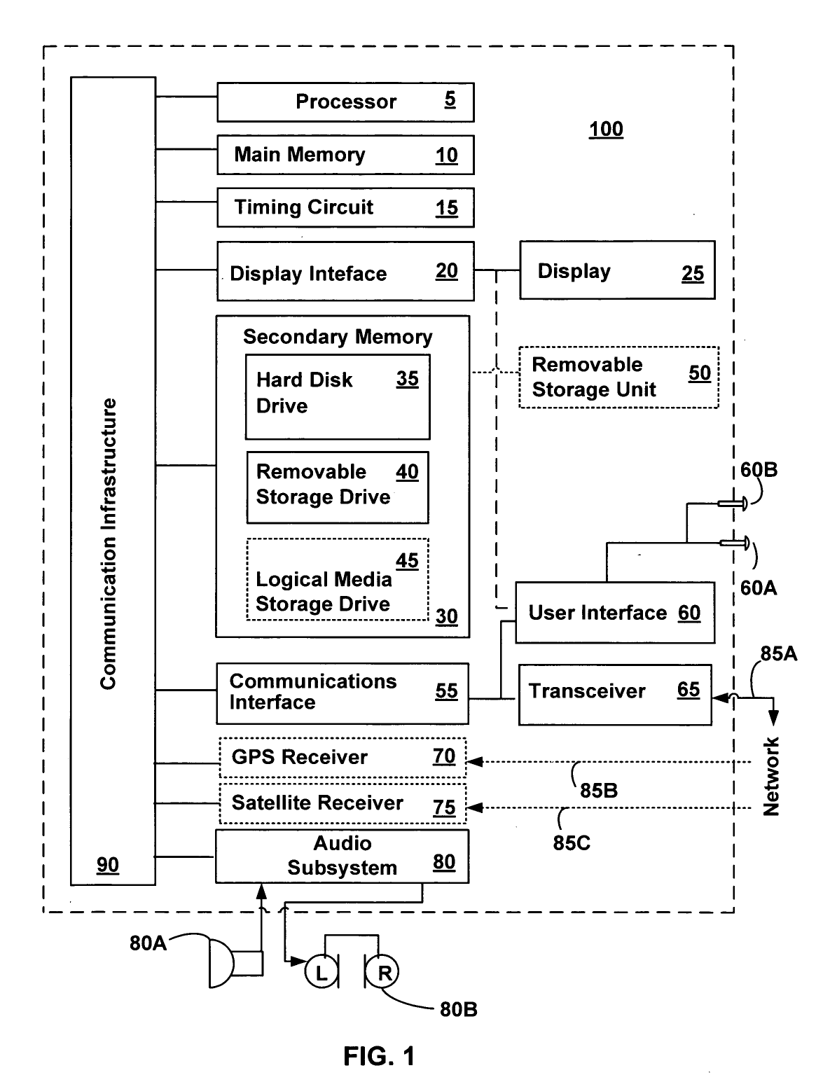

Referring to FIG. 1, a generalized block diagram of a media player 100 is depicted which may be portable in many embodiments. The media player 100 includes a communications infrastructure 90 used to transfer data and memory addresses where data files are to be found and control signals among the various components and subsystems associated with the media player 100. A processor 5 is provided to interpret and execute logical instructions stored in the main memory 10. The main memory 10 is the primary general purpose storage area for instructions and data to be processed by the processor 5. The term “memory” is to be interpreted in its broadest sense and includes both main memory 10 and secondary memory 30. References to the term “datastore” should be interpreted as an alternative to the term “memory,” and includes the primary 10 and secondary memory 30. A timing circuit 15 is provided to coordinate programmatic activities within the media player 100 in near real time. The timing circuit 15 may be used as a watchdog timer, clock or a counter arrangement and may be programmable.

The processor 5, main memory 10 and timing circuit 15 are directly coupled to the communications infrastructure 90. A display interface 20 is provided to drive a display 25 associated with the media player 100. The display interface 20 is electrically coupled to the communications infrastructure 90 and provides signals to the display 25 for visually outputting both graphical displays and alphanumeric characters.

The display interface 20 may include a dedicated graphics processor and memory (not shown) to support the displaying of graphics intensive media. The display 25 may be of any type (e.g., cathode ray tube, gas plasma) but in most circumstances will usually be a solid state device such as liquid crystal display (LCD). A secondary memory subsystem 30 is provided which houses retrievable storage units such as a hard disk drive 35, a removable storage drive 40, an optional logical media storage drive 45 and an optional removal storage unit 50. One skilled in the art will appreciate that the hard drive 35 may be replaced with flash RAM. The removable storage drive 40 may be a replaceable hard drive, optical media storage drive or a solid state flash RAM device. The logical media storage drive 45 may include a flash RAM device, an EEPROM encoded with playable media, or optical storage media (CD, DVD). The removable storage unit 50 may be logical, optical or of an electromechanical (hard disk) design.

A communications interface 55 subsystem is provided which allows for standardized electrical connection of peripheral devices to the communications infrastructure 90 including, serial, parallel, USB, and Firewire™ connectivity. For example, a user interface 60 and a transceiver 65 are electrically coupled to the communications infrastructure 90 via the communications interface 55. For purposes of this specification, the term user interface 60 includes the hardware and software by which a user interacts with the media player 100 and the means by which the media player 100 conveys information to the user.

In addition, the user interface 60 may include the display interface 20 and an operatively coupled display 25. The transceiver 65 facilitates the remote exchange of data and synchronizing signals between the media player 100 and other devices in network communications 85A with the media player 100.

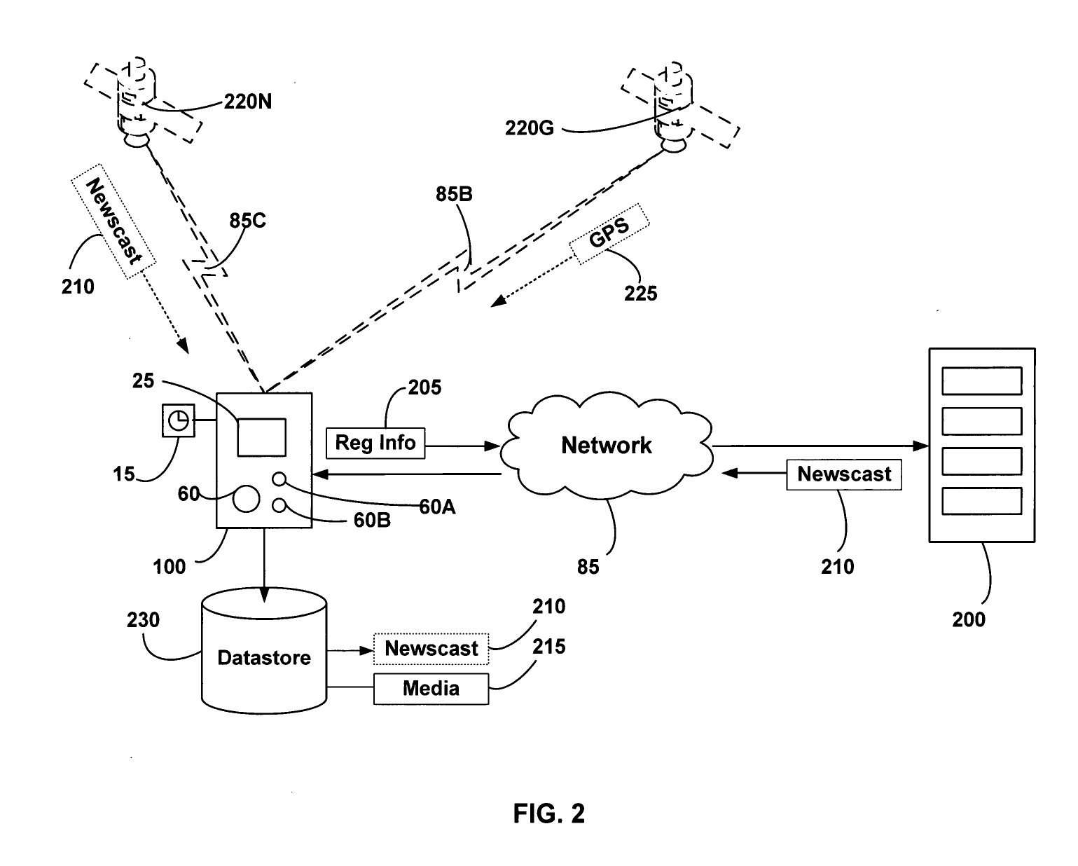

One such device that may be in communication with the media player 100 is a remote content server 200 (FIG. 2) from which contemporaneous media content may be received by the media player 100. For simplicity, contemporaneous media content are hereinafter referred to generically as “newscasts” 210 (FIG. 2).

The newscasts 210 contain time sensitive informational media content with respect to the time at which each newscast 210 is provided by the remote content server 200 to the media player 100. The remote content server 200 may provide the newscasts 210 directly to the media player 100 or through intervening remote servers coupled to the network 85A. The remote content server 200 may be a single service provider or a plurality of content service providers as well.

The transceiver 65 is envisioned to be of a radio frequency type normally associated with computer networks for example, wireless computer networks based on BlueTooth™ or the various IEEE standards 802.11x, where x denotes the various present and evolving wireless computing standards, for example WiMax 802.16 and WRANG 802.22.

Alternately, digital cellular communications formats compatible with for example GSM, 3G, CDMA, TDMA and evolving cellular communications standards. Both peer-to-peer (PPP) and client-server models are envisioned for implementation. In a third alternative embodiment, the transceiver 65 may include hybrids of computer communications standards, cellular standards and evolving satellite radio standards. The user interface 60 employed on the media player 100 may include a pointing device (not shown) such as a mouse, thumbwheel or track ball, an optional touch screen (not shown); one or more push-button switches 60A, 60B; one or more sliding or circular rheostat controls (not shown) and one or more additional switches (not shown.) The user interface 60 employed on the media player 100 may also include a vibratory unit (not shown) for alerting a user as to the receipt of a current newscast 210 through a non-auditory sensory modality prior to the play of the currently downloaded newscast 210.

The user interface 60 provides interrupt signals to the processor 5 via the communications infrastructure 90 that may be used to interpret user interactions with the media player 100. One skilled in the art will appreciate that the user interface devices which are not shown are well known and understood. The user interface 60 may be used to monitor a user's interaction with one or more push-button switches 60A, 60B.

One push button switch 60A may be used, for example, to enable a user to request a current newscast to be accessed immediately and played after a currently playing media item completes playing substantially in its entirely. The second push button switch 60B may, for example, be used to adjust the newscast update interval by some increment upon each press. For example, the news update interval may be increased by 1 minute each time the button switch 60B is pressed. An interrupt circuit may be incorporated into the hardware and/or software supporting the communications infrastructure 90, user interface 60, and/or audio subsystem 80 to change settings of the media player 100 using voice commands or other non-dexterous interactions. For example, a user pressing a button 60A, 60B, making a selection from the display 25, issuing a voice command 80A, or otherwise indicating through a user interface 60 a desire that the media player 100 begin performing an intelligent newscast playback process in which contemporaneous newscasts 210 are received over a network 85 and stored in a temporary memory of the datastore 230 (FIG. 2). The datastore 230 may also include a permanent or semi-permanent local library or playlist of media files 215A-215D.

A global positioning system (GPS) receiver 70 may be operatively coupled to the communications infrastructure 90 to provide positional information 225 (FIG. 2) to the remote content server 200. The positional information 225 may be used by the remote content server 200 in some embodiments of the present invention to customize the content of the newscast 210 returned to the media player 100 such that the newscast 210 includes information that is location or regionally specific to the user's current location.

The location specific information may include, for example, weather or traffic information that is specifically selected and/or generated for the current GPS location of the media player 100. It should be noted that alternate position and/or orientation tracking technologies may be used instead of or in addition to the GPS receiver 70 for providing current positional and/or orientational information relating to the media player and/or the user of the media player.

In another embodiment, a satellite receiver 75 is provided which allows reception of commercial satellite content broadcasts. The media player 100 can be programmed to receive specific contemporaneous newscasts which are downloaded and stored in the temporary memory of datastore 230 for future playback in accordance with the user's preferences. The transceiver 60, GPS receiver 70 and satellite receiver 75 may share common resources or devices such as a multi-frequency antenna 85B, 85C or network connection 85A.

Lastly, an audio subsystem 80 is provided and electrically coupled to the communications infrastructure 90. The audio subsystem 80 provides for the playback of digital media, for example, multi or multimedia encoded in any of the exemplary formats MP3, AVI, WAV, MPG, QT, WMA, AIFF, AU, RAM, RA, MOV, MIDI, etc. The audio subsystem 80 may include a microphone input port 80A for input of voice commands and a headphone, headset, ear buds or speaker output 80B. Connection of the microphone 80A and/or headphones 80B includes both traditional cable and wireless arrangements such as BlueTooth™ as is known in the relevant art.

As referred to in this specification, “media” refers to video, audio, streaming and any combination thereof. In addition, the audio subsystem 80 is envisioned to optionally include features such as graphic equalization, volume, balance, fading, base and treble controls, surround sound emulation, and noise reduction.

One skilled in the art will appreciate that the above cited list of file formats is not intended to be all inclusive. The media player 100 includes an operating system, the necessary hardware and software drivers necessary to fully utilize the devices coupled to the communications infrastructure 90, media playback and recording applications and at least one update service application operatively loaded into the main memory 10.

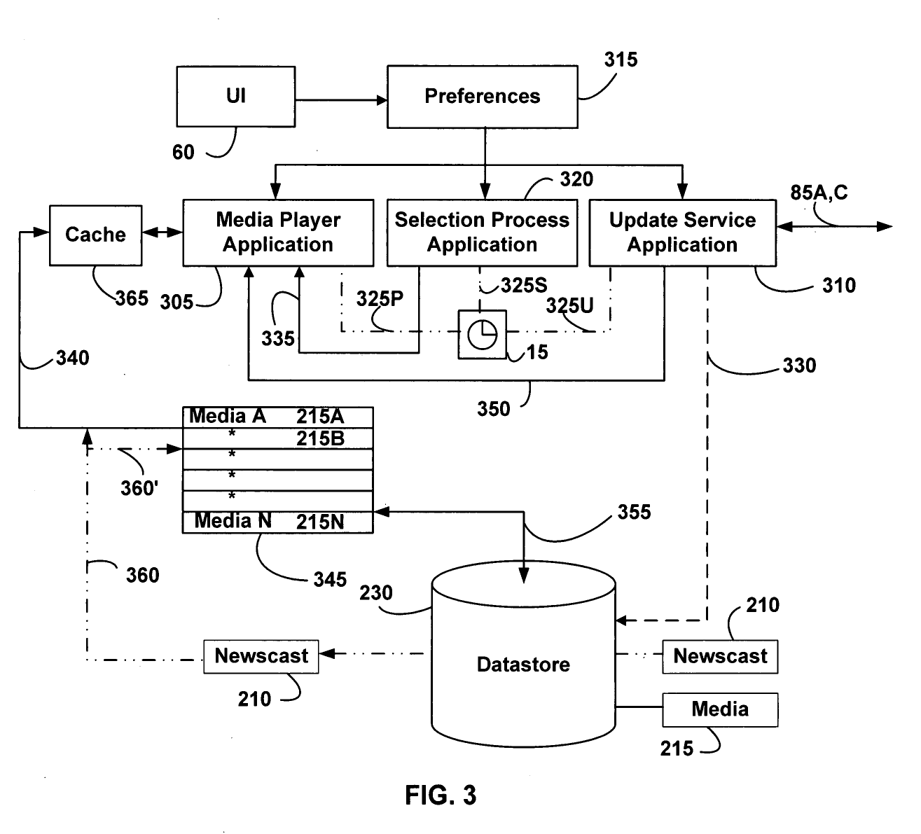

Referring to FIG. 2, a general block diagram is provided which depicts the basic arrangement of the media player 100, network 85 and remote content server 200. In this exemplary embodiment, the media player 100 is in communications with the remote content server 200 over a network 85, for example the Internet. A user desiring information from the remote content server 200 may provide registration information 205, such as a name, address, zip code, or other unique identifying information along with preference information regarding the content desired from the remote content server 200. The user establishes user preferences 315 (FIG. 3) for when the newscasts 210 are to be downloaded and/or played. The user preferences 315 are provided via the user interface 60, related controls 60A, 60B and the display 25 associated with the media player 100. In some embodiments, the user preferences 315 are entered by the user on an alternate computing device, for example, through a user interface of a desktop computer which are then transferred and/or downloaded to the media player 100.

With respect to user preferences, the user may establish a newscast download frequency based on a specified time interval at which the user desires updated newscasts 210 to be downloaded by the media player 100. This time interval is referred to herein as the News Update Interval. For example the news update interval may be set at 20 minutes in which case the media player will download updated newscasts from the remote content server at a frequency that corresponds approximately to every 20 minutes. In addition, the user preferences may establish a play frequency for newscasts 210 based upon a specified time interval 15 at which the user desires newscasts 210 to be approximately played by the media player 100. This value is referred to herein as the News Play Interval. In many instances the News Play Interval is automatically set to the same value as the News Update Interval although in other embodiments it could be set to a different value.

As an example, when the News Play Interval is set to 20 minutes the media player 100 will automatically play the most recently received newscast 210 at a frequency that is approximately every 20 minutes. The frequency may be approximate since an embodiment delays a newscast play until after a currently playing local media file 215 has completed play, such that one or more media files 215 are not interrupted by the newscast 210, thereby providing a seamless newscast presentation experience. Thus, when the 20 minute interval is expired, the then currently playing media file 215 will finish playing before the newscast 210 is played. In some instances the newscast 210 will play slightly prior to the expiration of the 20 minute time interval if a previous media file 215 has just completed playing. In some instances a plurality of media files 215 will automatically complete play after the newscast has been received and before the newscast is automatically played. In generally the number of media files 215 that complete play after the newscast has been received is dependent upon the amount of elapsed time that remains within a defined News Play Interval as well as upon the time durations of each of the currently playing and pending media files 215.

In an embodiment, a satellite 220G provides GPS signals 85B which are used by the GPS receiver 70 to provide approximate and contemporaneous location information to the remote content server 200. This arrangement is particularly well suited for receiving contemporaneous traffic and weather information in a particular locale. Alternately, the media player 100 may receive newscasts 210 from the remote content server 200 that are tailored to a particular location of interest dependent upon location information either entered by the user or relayed to the remote content server 200 over the communications network 85.

In another embodiment, a newscast 210S may be received 85C by the media player 100 using a satellite 220N broadcast service. This embodiment is useful in that receipt of newscasts 210S may not wholly reliant on connecting to a terrestrially based network 85.

FIG. 3 depicts an exemplary programmatic arrangement where an update service program 310 receives the user preferences 315 entered by a user through the user interface 60 or received from another computer as described previously. The user preferences 315 allow a user to customize the newscast receipt frequency, the newscast play frequency, the local media selection process settings and media playback settings. For simplicity and ease of understanding, three exemplary applications are provided to receive, store and intelligently playback a received newscast 210.

A media playback application 305 is provided which is programmed to play back 340 the local media files 215 and received newscasts 210. In the depicted embodiment, the media player application 305 is an existing program resident in the media player 100 which is generally unmodified, other than providing interface handles 325P to the timing circuit 15, selection process application 320 and update service application 310.

The update service application 310 is programmed to receive and store the newscasts 210 in accordance with the user preferences 315 at predefined intervals measured 325U by the internal time circuit 15. In one embodiment, the update service application 310 is configured as a web enabled application or browser applet operated as background process which receives and stores 330 newscasts 210 in the datastore 230 transparent from the retrieval 355 and playing 340 of the local media files 210. The update service application 310 may be configured as an object controlled by the media player application 305 and/or the selection process application 320.

The selection process application 320 is programmed to control the type of local media file retrieval 355 and playback 340 mechanism the user has specified in the user preferences 315 at predefined intervals measured 325S by the internal time circuit 15. The types of playback mechanisms include random selection, intelligent selection, playlist selection 345, and manual selection. In an embodiment, the selection process application 320 provides 335 a playlist 345 containing reference to the local media files 215 to be played 340 by the media player application 305. Each local media file 215 to be played is retrieved 355 from the datastore 230 by the media player application 305 and loaded into a common memory area 365.

The common memory area serves as a type of pre-fetch memory or memory cache 365 in which the local media files 215 or newscasts 210 are loaded for play by the media player application 305. The update service process application 310, in accordance with the entered user preferences 315, causes 350 the media player application 305 to retrieve 355 a stored newscast 210 from the datastore 230 and load 360 the retrieved newscast 210 into the memory cache 365 after a currently playing media file 215 has completed play. In this embodiment, the playlist 345 received from the selection process application 320 does not need to be modified in order to play 360 the newscast 210. The retrieved 360 newscast 210 is then played by the media player application 305 after a currently playing local media file 215A-N has completed play.

The actual mechanism employed by the update service application 310 for causing the media player application 305 to retrieve the newscast 210 from the temporary datastore 230 is not critical. For example, the update service application 310 may include providing an interrupt signal and a memory address 360 of the newscast 210 to be played in the temporary datastore 230, temporarily inserting 340 the newscast in the cache 365 ahead of the next media file 215N scheduled for play, or temporarily adding 360′ the newscast 210 or addressing indicia thereof to a position 215B in the playlist 345 and deleting the temporary addition after the newscast 210 has completed play.

Once the retrieved newscast 210 has completed play, the media player application 305 resumes the original playback mechanism 320 and playlist 345 selected and continues the retrieval 355 and playback 340 of local media files 215 from the datastore 230. One skilled in the art will appreciate that the media player application 305, the update service application 310, and the selection process application 320 may exist in separate, combined or unity programmatic forms using contemporary object oriented programming or other programmatic methods.

The user preferences 315 may be established by a setup routine which is executed when the user wishes to receive contemporaneous newscasts 210 from a remote content server 200 and/or satellite broadcast 220N. Examples of various types of information which may be entered as user preferences is provided below in Table 1, User definable preferences. It is envisioned that each newscast source may have associated user preferences.

TABLE 1
User definable preferences
Local Media Play Preference: Random; Intelligent Select; Playlist; Manual

| | |
|---|---|
| Type: | News; Weather; Sports; Traffic; Financial; |
| | Other |
| Maximum Length: | 1 − n minutes; File Size n megabytes; None |
| Input: | COM#; PORT#; UNIT#; USB; |
| | WIFI; BLUETOOTH |
| New Update Interval: | 1 − n minutes |
| Delete After Play?: | YES; NO; PROMPT; MANUAL |
| News Play Interval: | 1 − n minutes |
| Allow Manual Override: | YES; NO |
| Web Address(es): | URL1; URL2; |
| Authentication Required?: | YES; NO |
| Login: | USERNAME: |
| | PASSWORD: |
| | CREDENTIAL: |
| Identify Location?: | YES; NO |
| Location ID: | GPS; ZIP; City Name; Area Code; Other |

The user play preferences 315, which are used by the selection process application 320, may be set to retrieve 355 local media files 215 for play using a random play mechanism. The random playback mechanism is programmed to randomly select one or more local media files 215 for play from the library of media files in the datastore 230.

Alternately, the intelligent selection mechanism may be implemented which selects local media files 215 based on past user histories and preferences associated with the individual media files 215. Intelligent selection mechanisms are described in detail in co-pending U.S. patent application Ser. No. 11/285,534 filed on Nov. 22, 2005 and Ser. No. 11/267,097 filed on Nov. 3, 2005, both to the instant inventor. Both the latter and former patent applications are herein incorporated by reference in their entirety.

Another common playback mechanism utilizes a user's established script or playlist 345 to retrieve a predetermined set of local media files 215 from the datastore 230 in a predetermined sequential order 325S as directed by the entries included in the playlist 345 by either the user or the selection process application 320. In this embodiment, the user selects the media files 215A-215N which are desired to be played in the order listed in a playlist 345 by a media player application 305. In this exemplary embodiment, the playlist 345 provides a unique identifier for each media file desired such that it can be accessed from the library of media files in datastore 230 and played by the media player application 305 in the predetermined sequence as defined by the playlist 345. The last common playback mechanism is simple manual selection via the user interface 60.

In an optional embodiment, the user may specify a priority or hierarchy for each remote source of newscast information. This optional programmatic feature is useful when several newscasts are to be received and a user desires to playback one or more newscasts 210 based on the received newscast priority setting.

In another optional embodiment, the user may specify a type of newscast 210 to be accessed. For example, newscasts may be selected having broad categories designated as news, weather, sports, traffic, financial or user defined. In another optional embodiment, the user may specify dimensional characteristics of the newscast 210 such as a maximum length in time or maximum file size to be received by the media player 100. This optional feature limits the playback time required and/or temporary storage allocated to receiving and playing the received newscasts.

In another optional embodiment, the user may specify which device and/or communication channels coupled to the communications interface 55 should be used to receive the newscasts 210. The ability to specify which communications channels will be used allows a variety of internal and external devices to be connected to the media player 100. For example, a particular media player 100 may not have an internal GPS receiver 70 installed. However, a communications channel may be allocated to receive GPS data from; for example, an external GPS receiver coupled to the media player 100 via a universal serial bus (USB) port or BlueTooth™ connection to the communications interface 55. In another optional embodiment, the user may specify whether received newscasts 210 are to be deleted from the temporary datastore 230 after play. The user may elect to save, delete automatically, prompt the user before deleting or let the user manually delete the accumulated newscasts 210 in the datastore 230.

The news update interval setting allows the user to specify how often the update service application 310 will attempt to receive a newscast update 325U from the communications network 85, 85A, 85C without interruption of a currently playing media file 215A and/or playlist 345. Various embodiments of the newscast update interval 325U are envisioned which allows the user to specify a specific or approximate interval of time for receiving the newscast updates 325U. In one embodiment, the newscast updates 325U are received using an automated process which performs the newscast updates 325U when the processor 5 associated with the media player 100 is either idle or has available resource time for running the update service application 310. In another embodiment, the user may set newscast updates 325U to be accomplished manually by the user interacting with the user interface 60.

In various news update interval setting embodiments, the update service application 310 utilizes the internal timing circuit 15 included in the media player 100 and entered user preferences 315 to determine when to receive an updated newscast 210. In general, the newscast update interval may be approximated based on the time required to play a defined portion of the playlist 345, and/or is performed at a regular time intervals, rate, or frequency as defined by the news update interval and user preference 315. The received newscast 210 is then stored in a temporary datastore 230 for later automatic play by the media play application 305 after one or more currently playing local media files 215A-215N has completed play to the user. This is generally performed at approximately at a regular time interval 325U as defined by the News Play Interval value entered and/or adjusted by the user.

The media player application 305 utilizes the internal timing circuit 15 to determine when the received newscast(s) 210 are to be played based approximately upon the elapsed time since a previous newscast 210 was played and/or based upon the elapsed time since the newscast playing operation was begun. Again, the timing may be approximate because the newscast 210 is played such that it does not interrupt a currently playing media file 215 when the elapsed time equals the News Play Interval. Instead, the then currently playing media file 215 is played 340 to completion prior to the play of the newscast 210, thereby providing the seamless integration of locally stored media file playing and, remotely accessed newscast media playing.

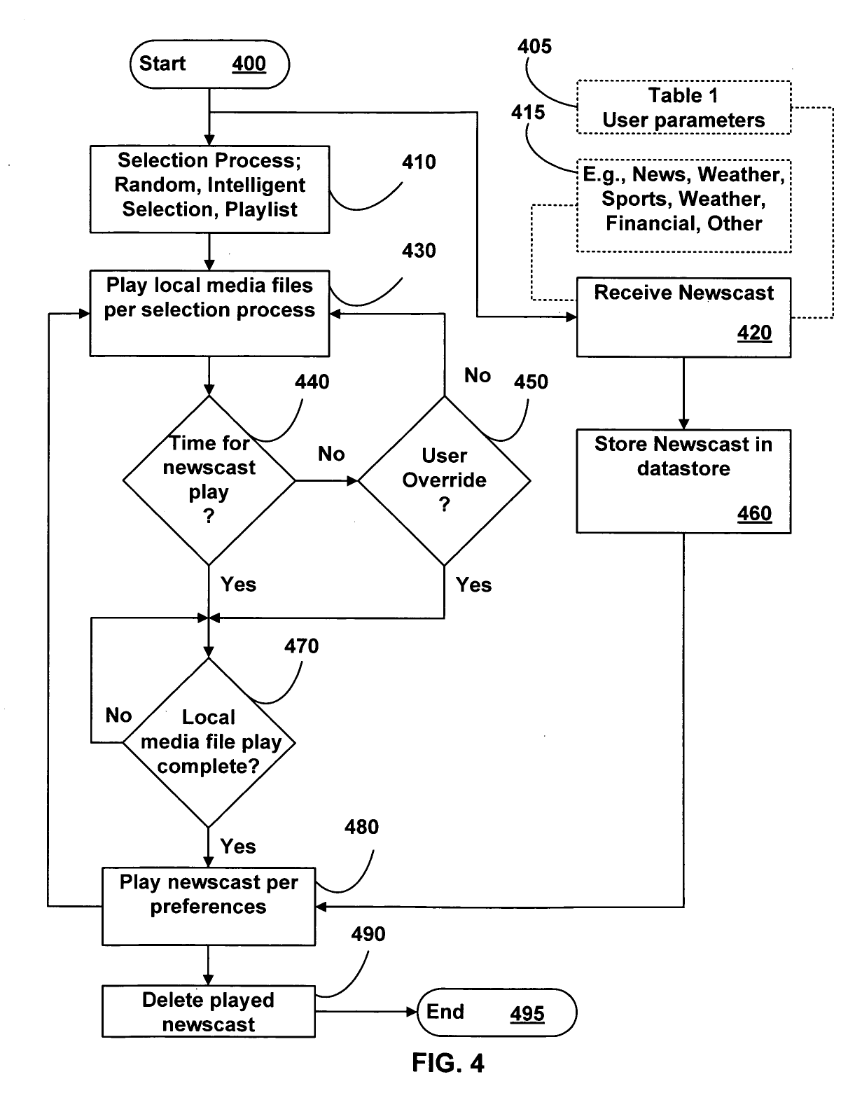

Once the newscast 210 is played 360 to completion, the next scheduled 325S and/or selected local media file 215N is immediately played continuing the seamless integration of locally stored media file playing and remotely accessed newscast media playing. This process will be described in additional detail with respect to the discussion provided for FIG. 4 below.

In another optional embodiment, the user may specify whether a received newscast may override play of a currently playing media file 215. This setting allows a newscast of a particular type, source or priority designated by the user to interrupt the play of a currently playing media file 215 and begin playing the newscast. This feature is useful for emergency newscasts or user designated important newscasts. Thus, while the preferred embodiment is such that newscasts 210 are played after the seamless completion of one or more currently playing local media file 215, certain embodiments may include a specialized emergency feature in which a newscast 210 that is designated to be of a particular type, source, or priority level, may be played immediately upon receipt from the remote content server 200, interrupting the currently playing media file 215 because of the urgency of the informational content contained. In various embodiments, the interrupted media file will automatically resume playing after the interrupting newscast has completed play. In general, the media player 100 is configured to resume playing the interrupted media file 215 from approximately the point at which it ceased playing prior to the interruption. In other embodiments, the media player 100 may be configured to resume playing the interrupted media file 215 from another point in which it ceased playing.

The web address(es) settings may in some embodiments, allow the user to select sources of newscasts 210 to be received by the update service application 310. Various embodiments allow the user to designate at least one primary and an alternate universal resource locator (URL) address for receipt of newscasts. One skilled in the art will appreciate that other addressing techniques may be utilized which do not rely on URLs to receive newscasts from a particular newscast provider.

In certain embodiments, it may be necessary to authenticate the user to one or more remote content servers 200. If authentication is required, login information, for example, username, password and/or other user credentials (e.g., two factor authentication code, digital certificate exchange, etc.) may be provided to a remote content server 200 at a designated URL to allow receipt of the newscast updates by the update service application 310. Where authentication is required, the media player 100 may be used as an authentication token.

In another optional embodiment, the user may specify whether to identify a location in which the media player 100 is currently situated. This feature is generally used for embodiments whereby the media player 100 is portable and the content of the newscast 210 is desired to be customized to the then current location of the portable media player 100. For example, geographical coordinates provided by a GPS receiver 70 may be periodically sent to a remote content server 200 in order to receive near real time newscasts 210 that are customized to the particular current location of the user. Other location identifying information, for example, city name, state name, zip code, area code or user specified information may be provided as well. This feature is useful for receiving newscasts 210 related to spatially and/or temporally variable situations such as traffic problems and weather. This feature is also useful in receiving local news and sports information for a particular town, city, county, state, or other local region. With respect to sports information, the user may also specify specific types of sports, specific sporting teams, and/or specific sporting events in which the user is interested in. With respect to news information, the user may specify a desired mix of local, national, and/or international informational content as well as define locations relating to each.

Referring to FIG. 4, an exemplary process flow chart is depicted. The process may be initiated 400 automatically or in response to a user interaction with the user interface 60 associated with the media player 100.

Once the newscast update process is initiated 400, the user selected playback selection mechanism 410 implemented by the selection process application 320, which provides a set of local media 215A-N to be played by the media player application 305. The first of the local media files to be played is retrieved from the local datastore 230 and played by the media player application 430 in accordance with the entered user preferences 315 and media selection process implemented. The user parameters comprising the user preferences 315 are shown in Table 1 above 405. The types of newscasts 415 are included in the selected and/or entered user preferences 315.

The update service application 310 is started and receives one or more newscasts 420 which are stored 460 temporarily in a datastore 230. The datastore 230 includes both primary, secondary and cache memory locations. The selection process application 320, in accordance with the entered user preferences 315 keeps track of the number of local media files played by the media player application 305 and/or the amount of time elapsed 15 remaining in the current news play interval.

If it is not time for a newscast playback 440 and a user override 450 has not been received, the media player application 305 continues playing 430 of the local media files 215 as directed by the selection process application 320. Alternately, if is not time for a newscast playback 440 but a user override signal has been detected 450, the selection process application 320 determines if the currently playing local media file 215 has completed play 470. If the local media file 215 has not completed play, the selection process application 320 waits for the currently playing local media file 215 to complete play. If the currently playing local media file 215 has completed play 470, the selection process application 320 causes the media player application 305 to retrieve and play the newscast 210 from the temporary datastore 230.

The actual mechanism employed by the update service application 310 for causing the media player application 305 to retrieve and play the newscast 210 from the temporary datastore 230 is not critical. For example, the update service application 310 may include providing an interrupt signal and memory address of the newscast 210 to be played in the temporary datastore 230, temporarily inserting the newscast in a queue, cache or pre-fetch memory ahead of the next local media file 215 scheduled for play, or temporarily adding the newscast 215 or addressing indicia thereof to the playlist 345 and deleting the temporary addition after the newscast 210 has completed play.

In either case, once the currently playing media file 215 has complete play 470, the media play application 305 retrieves the newscast 210 from the datastore 230 and plays 480 the newscast 210. Once the newscast 210 has completed play, the newscast 210 is generally deleted 490 and the user specified media file selection and playback process resumes 430.

In further iteration, if it is time for a newscast playback 440, for example as determined by a measure of elapsed time since the previous newscast play and one or more defined update intervals, the selection process application 320 again determines if the currently playing local media file 215 has completed play 470. As before, if the local media file 215 has not completed play, the selection process application 320 waits for the currently playing local media file to complete play. If the local media file 215 has completed play, the selection process application 320 causes the media player application 305 to retrieve and play the newscast 210 from the temporary datastore 230 as previously described. Once the currently playing media file 215 has complete play 470, the newscast 210 is retrieved from the temporary datastore 230 by the media player application 305 and played 480.

As before, the newscast 210 is generally deleted from the temporary datastore 230 after play 490. Once the newscast 210 completes play, the user specified media file selection and newscast playback process resumes 430 as before in a cycle unless the user decides to manually end the process 495.

It should be noted that while much of the description herein is provided with respect to a single newscast definition, some embodiments are contemplated to support multiple simultaneous newscast definitions. For example a user may define and/or select that plurality of newscasts 210 be received and played, each having a differing informational content definition and/or differing update intervals. For example, a user may establish a first newscast definition that includes sports and weather informational content and is defined such that it is updated and played upon a 20 minute frequency cycle. That user may also establish a second newscast definition that is configured to include traffic and financial informational content and is defined such that it is updated and played upon a 35 minute frequency cycle. In this way the user will receive a plurality of newscasts, each having differing informational content and/or differing updates and play cycles.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope, be apparent to persons of ordinary skill in the art. As such, the foregoing described embodiments are provided as exemplary illustrations and descriptions. They are not intended to limit the invention to any precise form described. In particular, it is contemplated that functional implementations described herein may be implemented equivalently in hardware, software, firmware, and/or other available functional components or building blocks. No specific limitation is intended to a particular arrangement or event sequence. Other variations and embodiments are possible in light of above teachings, and it is not intended that this Detailed Description limit the scope of invention, but rather by the Claims following herein.

What is claimed:

1. A method for playing newscasts on a media player comprising:
playing a predetermined set of local media files retrieved from a local datastore over an interval;
receiving a newscast from a remote content server over a communications link during said interval;
storing said newscast in a temporary datastore during at least a portion of said playing of said predetermined set of local media files;
completing said playing of at least one of said predetermined set of local media files after said newscast has been stored in said temporary datastore during said interval;
automatically playing said newscast after said at least one of said predetermined set of local media files has completed playing but within said interval; and,
automatically resuming play of at least a portion of said predetermined set of local media files after said newscast has completed play.

2. The method according to claim 1 wherein said predetermined set of local media files is defined at least in part by a playlist accessible by said media player.

3. The method according to claim 1 wherein said newscast is automatically deleted from said temporary datastore after said newscast has completed play.

4. The method according to claim 1 wherein said automatically playing of said newscast is performed in response to a user interaction with a user interface associated with said media player.

5. The method according to claim 4 wherein said user interaction causes said newscast to play immediately after a currently playing local media file completes play.

6. The method according to claim 4 wherein said user interaction is provided by a designated pushbutton switch associated with said user interface.

7. The method according to claim 1 wherein the claim elements comprising claim 1 are repeated in a cycle defined by one or more user preferences.

8. The method according to claim 7 wherein said cycle is performed at a rate dependent at least in part upon a predetermined news update interval, a news play interval or both.

9. The method according to claim 8 wherein said predetermined news update interval is one of, user defined, user adjustable and a combination thereof.

10. The method according to claim 1 wherein said newscast received from said remote content server is dependent at least in part upon a predefined set of user parameters accessible by said remote content server.

11. The method according to claim 1 wherein at least a portion of said newscast received from said remote content server includes informational content that is generally contemporaneously relevant to positional information sent by said media player to said remote content server.

12. The method according to claim 10 wherein at least one of said set of user parameters includes a unique identifier relationally associated with either said media player or a user of said media player.

13. The method according to claim 11 wherein at least a portion of said positional information is provided by a GPS receiver functionally coupled to said media player.

14. The method according to claim 10 wherein at least a portion of said set of user parameters defines one or more types of informational content to be included in said newscast.

15. The method according to claim 14 wherein said one or more types of informational content is one of; news, traffic, weather, financial, sports and any combination thereof.

16. The method according to claim 1 wherein at least a portion of said set of media files includes a plurality of musical songs.

17. A system for playing newscasts on a media player comprising:
a media player having operatively installed therein:
a datastore local to said media player having a plurality of local media files retrievably stored therein;
a transceiver functional to receive a newscast from a remote content server over a communications link;
a selection process application programmed to automatically select a set of local media files from among said plurality of local media files for play within an interval;
a media player application programmed to automatically play at least a portion of said selected set of local media files during said interval; complete said play of at least one of said selected set of local media files even after said newscast has been received during said interval; play said newscast within said interval; and, automatically resume play of at least a portion of said selected set of local media files after said newscast has completed play; and,
an update service application coupled to said transceiver; said update service application being programmed to at least store said newscast in a temporary datastore; and, cause said media player application to play said newscast after said at least one of said selected set of local media files has completed play but within said interval.

18. The system according to claim 17 wherein said selection process application is further programmed to select said set of local media files based on one of, a user defined playlist, a random selection process, an intelligent selection process and any combination thereof.

19. The system according to claim 17 wherein at least some informational content incorporated into said newscast is dependent at least in part on a predefined set of user parameters.

20. The system according to claim 19 wherein at least one of said set of user parameters includes positional information.

21. The system according to claim 20 wherein at least a portion of said positional information is provided by a GPS receiver functionally coupled to said media player.

22. The system according to claim 19 wherein said informational content is one of; news, traffic, weather, financial, sports and any combination thereof.

23. A computer program product embodied in a tangible form including instructions executable by a processor associated with a media player to:
play a predetermined set of local media files retrieved from a local datastore over an interval;
receive a newscast from a remote content server over a communications link during said interval;
store said newscast in a temporary datastore during at least a portion of said play of said predetermined set of local media files;
automatically play said newscast only after at least one of said predetermined set of local media files has completed play but within said interval; and,
automatically resume play of at least a portion of said predetermined set of local media files after said newscast has completed play but within said interval.

24. The computer program product according to claim 23 wherein said predetermined set of media files is defined at least in part by a playlist accessible by said media player,

25. The computer program product according to claim 24 wherein the claim elements comprising claim 24 are repeatable in a cycle defined by one or more user preferences.

26. The computer program product according to claim 25 wherein said cycle is performed at a rate dependent at least in part upon a predetermined news update interval, a news play interval or both.

27. The computer program product according to claim 23 wherein at least a portion of said set of media files includes a plurality of musical songs.

28. The computer program product according to claim 23 wherein said tangible form comprises magnetic media, optical media, logical media and any combination thereof.
